(19) United States
(12) Patent Application Publication
(10) Pub. No.: US 2014/0202155 A1
(43) Pub. Date: Jul. 24, 2014

(54) SOLAR THERMAL ELECTRIC POWER GENERATION SYSTEM

(71) Applicant: Hideaki Ota, Ibaraki-shi (JP)

(72) Inventor: Hideaki Ota, Ibaraki-shi (JP)

(73) Assignee: KAWASAKI JUKOGYO KABUSHIKI KAISHA, Kobe-shi, Hyogo (JP)

(21) Appl. No.: 14/238,944

(22) PCT Filed: Dec. 27, 2011
(86) PCT No.: PCT/JP2011/080232

§ 371 Date: Feb. 14, 2014

(51) Int. Cl. F03G 6/06; F02C 6/18; F01K 23/10

(52) U.S. Cl. CPC F03G 6/065; F01K 23/10; F02C 6/18
USPC 60/641.15; 60/39.182

(57) ABSTRACT

A solar thermal electric power generation system using heating medium that undergoes phase change between liquid phase and vapor phase, including a Fresnel type heat collectors for heating the heating medium by solar thermal energy, a gas turbine generating device for generating electric power while discharging exhaust gas, a heating device including a first channel through which the heating medium flows and a second channel which is located near the first channel and through which the exhaust gas from the gas turbine generating device flows, a vapor-liquid separating device for separating the heating medium having been heated by the heating device into vapor phase and liquid phase, and a turbine generating device driven by the heating medium in vapor phase separated by the vapor-liquid separating device. The heating device heats the heating medium in the first channel by the exhaust gas in the second channel.

### TECHNICAL FIELD

The present invention relates to a solar thermal electric power generation system that utilizes heating medium undergoing phase change between liquid phase and vapor phase and that utilizes solar thermal energy,

### BACKGROUND ART

As disclosed in Patent Literature 1, a solar thermal electric power generation system that utilizes heating medium and solar thermal energy (namely, solar heat) has been known. In the solar thermal electric power generation system disclosed in Patent Literature 1, first heating medium heated by solar heat transmits the solar heat to a heat storage tank so that the solar heat is stored in the heat storage tank. Second heating medium is heated by the heat stored in the heat storage tank and is subsequently heated further in a boiler device so as to be evaporated. The evaporated second heating medium drives a steam turbine generating device.

In order to heat the heating medium by solar heat, a solar heat collecting device that collects solar heat into the heating medium is used. Among solar heat collecting devices are parabolic trough type heat collectors, Fresnel type heat collectors (or linear Fresnel collectors), tower type heat collectors (or central tower collectors), and the like (see Patent Literatures 2 and 3). As shown in FIG. 12, a parabolic trough type heat collector has parabolic trough mirrors 1010 each having a section in shape of a parabola. The parabolic trough mirrors 1010 are configured so as to reflect sunlight toward a heat absorbing pipe 1012 which is provided at the focal point of the parabola and in which heating medium flows. Angles of inclination of the parabolic trough mirrors 1010 are adjusted in accordance with movement of the sun.

As shown in FIG. 13, a Fresnel type heat collector has a plurality of plane mirrors 1022. A heat absorbing pipe is provided above and in parallel with the plane mirrors 1022. The plane mirrors are configured so as to reflect sunlight toward the heat absorbing pipe 1020 in accordance with movement of the sun. An angle of inclination of each plane mirror 1022 is adjusted in accordance with movement of the sun.

As shown in FIGS. 14A-14B, a tower type heat collector has a tower 1032 including a top part 1030 in which heating medium flows and a plurality of plane mirrors 1034 (which will be referred to as heliostats hereinbelow) placed on a plurality of concentric circles, concentric semicircles or concentric polygons which have each of their centers on the tower 1032 and which have different distances from the tower 1032. The heliostats 1034 are configured so as to reflect sunlight toward the top part 1030 of the tower 1032. An angle of inclination of each heliostat 1034 is adjusted in accordance with movement of the sun.

Vacuum type pipes or non-vacuum type pipes are used as the heat absorbing pipes that are irradiated with the reflected sunlight (namely, heated by solar heat). The vacuum type pipe, having resistance to heat dissipation and little heat loss, is composed of a steel pipe through which the heating medium flows and a glass pipe enclosing the steel pipe, for instance. The space (namely, chamber) between the steel pipe and the glass pipe is kept in vacuum state. A coating film capable of selectively absorbing sunlight of specified wavelengths is formed on the outer surface of the steel pipe. The vacuum type pipes are often used in such systems that oil is used as the heating medium and that the parabolic trough type heat collector is used as the heat collecting device.

The non-vacuum type pipe is a simple steel pipe, for instance. The non-vacuum type pipe has more heat dissipation than the vacuum type pipe, but has an advantage of a simple structure that realizes low manufacturing cost and easy handling. The non-vacuum type pipes are often used in such systems that water is used as the heating medium and that the Fresnel type heat collector is used as the heat collecting device.

In Patent Literature 4 is disclosed a pipe through which heating medium flows and which stores heat of the heating medium. A solar thermal electric power generation system disclosed in Patent Literature 4 is configured so as to store the heat of the heating medium in heat storing medium provided in the pipe and so as to heat the heating medium by the heat stored in the heat storing medium. In order to selectively perform heat exchanging between the heating medium and the heat storing medium, there are provided a main supply pipe thermally connected to the heat storing medium, a bypass pipe thermally isolated from the heat storing medium, and control valves for making the heating medium flow to either the main supply pipe or the bypass pipe.

### CITATION LIST

### Patent Literature

PTL1: JP2007-132330 A
PTL2: JP2010-058058 A
PTL3: JP2009-197733 A
PTL4: WO2010/052710

### SUMMARY OF INVENTION

### Technical Problem

Intensity of solar thermal energy that reaches the ground (which will be referred to as Direct Normal Irradiance or DNI, abbreviated therefrom) changes according to seasons, hours, weather, places and the like. As changes in the direct normal irradiance in Denver, U.S.A. are shown in FIGS. 15A-15C, for instance, hours of available sunlight are different according to calendar days, and the daily direct normal irradiance differs according to daily hours. The direct normal irradiance sharply changes with sudden change in such the weather as clouds block the sun. That is, there is a possibility that solar heat may not sufficiently heat the heating medium. Accordingly, there is a possibility that sufficient electric power cannot be generated by the solar thermal electric power generation system which generates electric power by utilizing the heating medium (namely, such as water vapor) in vapor phase sufficiently heated by solar heat.

As a measure to cope with the problem, it is conceivable to store in a heat storing medium a portion of heat that the heating medium keeps after having been heated sufficiently or excessively by solar heat, and to heat the heating medium heated insufficiently by solar heat, by using the heat stored in the heat storing medium, as described in the solar thermal electric power generation system disclosed in Patent Literature 4. In order to make it possible to heat the heating medium at any time, it is required to provide a large quantity of heat storing medium for storing a large quantity of heat as well as a large container facility (namely, such as heat storage tank) for containing the large quantity of heat storing medium. As the result, this results in increase of manufacturing cost and maintenance cost of the solar thermal electric power generation system.

As another measure to cope with the problem, it is conceivable to use the parabolic trough type heat collector or the tower type heat collector that has comparatively higher efficiency of collecting solar heat (namely, higher efficiency of heating of heating medium) rather than the Fresnel type heat collector. However, the parabolic trough type heat collector and the tower type heat collector require higher manufacturing cost and higher maintenance cost than the Fresnel type heat collector.

It is an object of the invention to provide a solar thermal electric power generation system that has an inexpensive configuration and that is capable of sufficiently heating a heating medium and thus generating sufficient electric power even in such cases as short hours of available sunlight, low direct normal irradiance, and/or sharp change in direct normal irradiance.

### Solution to Problem

In order to achieve the object, the invention is configured as follows.

According to a aspect of the present invention, there is provided a solar thermal electric power generation system using heating medium that undergoes phase change between liquid phase and vapor phase, the solar thermal electric power generation system comprising: Fresnel type heat collectors for heating the heating medium by solar thermal energy, a gas turbine generating device for generating electric power while discharging exhaust gas, a heating device comprising a first channel through which the heating medium having been heated by the Fresnel type heat collectors flows and a second channel which is located near the first channel and through which the exhaust gas from the gas turbine generating device flows, the heating device for heating the heating medium in the first channel by the exhaust gas in the second channel, a vapor-liquid separating device for separating the heating medium having been heated by the heating device into vapor phase and liquid phase, and a turbine generating device driven by the heating medium in vapor phase separated by the vapor-liquid separating device.

### Advantageous Effects of Invention

According to the invention, using an inexpensive configuration, a heating medium can sufficiently be heated and thus the solar thermal electric power generation system is capable of generating sufficient electric power, even in such cases as short hours of available sunlight, low direct normal irradiance, and/or sharp change in direct normal irradiance.

### BRIEF DESCRIPTION OF DRAWINGS

The aspects and features of the invention will be apparent from the description concerning preferred embodiments with reference to the accompanying drawings, in which:

FIG. 1 is a conceptual illustration of an integrated solar combined cycle power plant in accordance with an embodiment 1 of the invention;

FIG. 2 is a schematic configuration of the integrated solar combined cycle power plant shown of FIG. 1;

FIG. 3 is a schematic configuration of a heating device;

FIG. 4 is a sectional view of the heating device shown in FIG. 3;

FIGS. 5A-5B are graphs showing relations between direct normal irradiance (DNI) and electric power output of a steam turbine;

FIG. 6 is a schematic configuration of a heating device of a comparative example;

FIG. 7 is a sectional view of a heating device of a modification of the embodiment 1;

FIG. 8 is a schematic configuration of an integrated solar combined cycle power plant of a comparative example;

FIG. 9 is a schematic configuration of a heating device in an integrated solar combined cycle power plant in accordance with an embodiment 2 of the invention;

FIG. 10 is a schematic configuration of a heating device in an integrated solar combined cycle power plant in accordance with an embodiment 3 of the invention;

FIG. 11 is a schematic configuration of a heating device in an integrated solar combined cycle power plant in accordance with an embodiment 4 of the invention;

FIG. 12 is an illustration showing a parabolic trough type heat collector;

FIG. 13 is an illustration showing a Fresnel type heat collector;

FIGS. 14A-14B are an illustration showing a tower type heat collector; and

FIGS. 15A-15C are graphs showing changes in direct normal irradiance that differs according to calendar days and according to daily hours.

### DESCRIPTION OF EMBODIMENTS

Hereinbelow, embodiments of the invention will be described with reference to the drawings.

### Embodiment 1

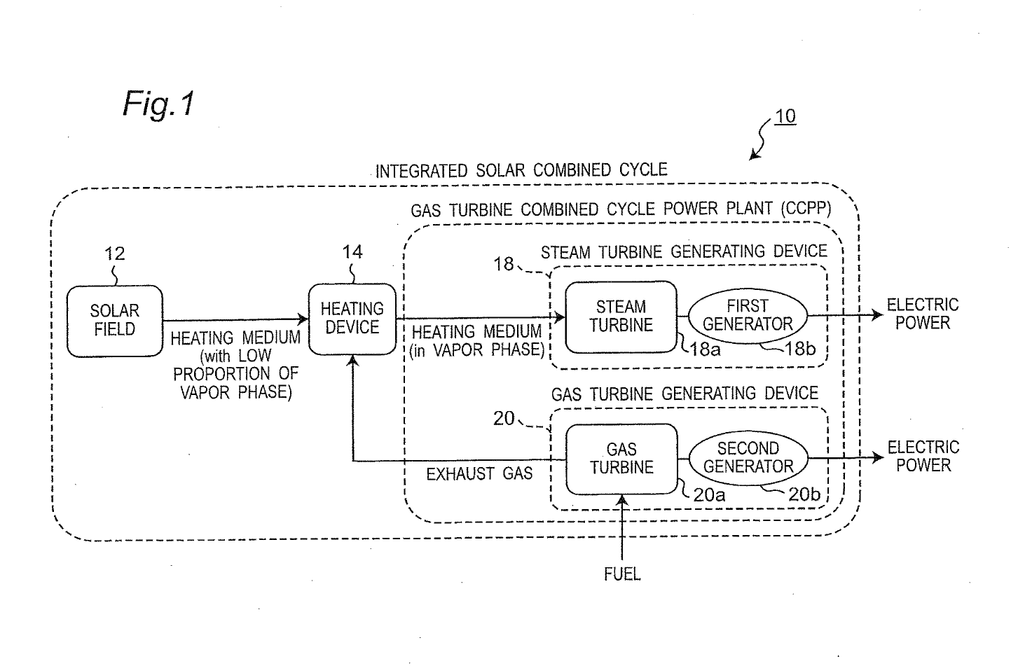

FIG. 1 conceptually shows a configuration of a solar thermal electric power generation system (namely, integrated solar combined cycle power plant) in accordance with an embodiment 1 of the invention.

The integrated solar combined cycle (namely, abbreviated as ISCC) 10 shown in FIG. 1 is an example of solar thermal electric power generation system in which electric power is generated by using solar heat and heating medium, and includes a plurality of electric power generation sources.

Herein, “heating medium” refers to a fluid capable of flowing while keeping heat. In the embodiment, inexpensive water is used as the heating medium that undergoes phase change between liquid phase and vapor phase.

As FIG. 1 shows, the integrated solar combined cycle power plant 10 has a solar field 12 for evaporating (namely, producing steam) the heating medium in liquid phase (namely, water) by solar heat, a heating device 14 for heating the heating medium that has been heated by the solar heat and that the vapor phase proportion thereof is less so as to increase the proportion of vapor phase, a steam turbine generating device 18 driven by the heating medium in vapor phase that has been heated by the heating device 14, and a gas turbine generating device 20 for generating electric power while supplying hot exhaust gas to the heating device 14.

The solar field 12, the heating device 14, and the gas turbine generating device 20 form a heating medium supplying device for supplying the heating medium in vapor phase to the steam turbine generating device 18. Such a system is referred to as a gas turbine combined cycle (namely, ccpp) power plant that generates electric power by using both the steam turbine generating device 18 and the gas turbine generating device 20, that heats and evaporates the heating medium in liquid phase by the exhaust gas discharged from the gas turbine generating device 20, and that generates electric power by driving the steam turbine by the heating medium in vapor phase.

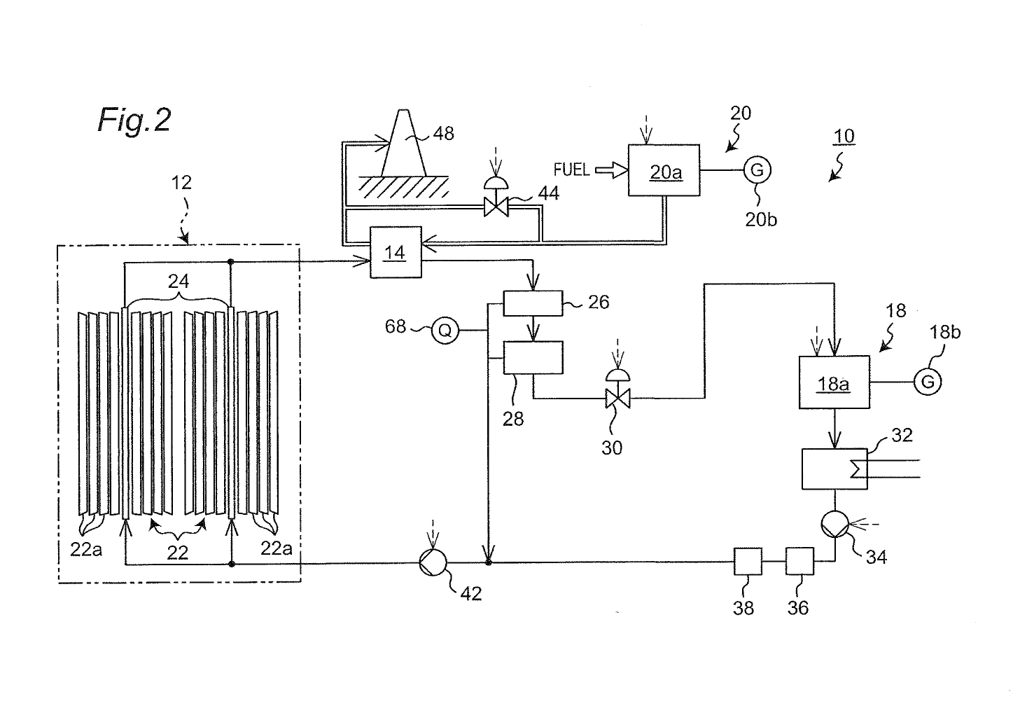

FIG. 2 shows a specific configuration of the integrated solar combined cycle power plant 10. A plurality of component elements of the integrated solar combined cycle power plant 10 will be described in accordance with stepwise description of the heating medium. The drawings show only principal component elements associated with the invention. There exist other component elements not being shown. It must be noted that the plurality of component elements described herebelow are associated with the invention but are not all component elements required for the integrated solar combined cycle power plant 10.

The solar field 12 includes Fresnel type heat collectors 22 that heat the heating medium in liquid phase by solar heat. The Fresnel type heat collectors 22 have a plurality of plane mirrors 22a for heating the heating medium in liquid phase that flows in heat absorbing pipes 24. The plane mirrors 22a are configured to reflect sunlight and to irradiate the heat absorbing pipes 24 with the reflected sunlight. Angles of inclination of the plane mirrors 22a are adjusted according to movement of the sun.

The heat absorbing pipes 24 of the invention may be either the vacuum type pipes or the non-vacuum type pipes. The vacuum type pipes have higher efficiency of heat collection but higher manufacturing cost. The non-vacuum type pipes have lower efficiency of heat collection than the vacuum type pipes but are more advantageous in equipment cost because they are less expensive.

The Fresnel type heat collector 22 is used as a heat collecting device for heating the heating medium by solar heat because the Fresnel type heat collector using the plurality of plane mirrors 22a of simple structure and low cost are less expensive than other heat collecting devices.

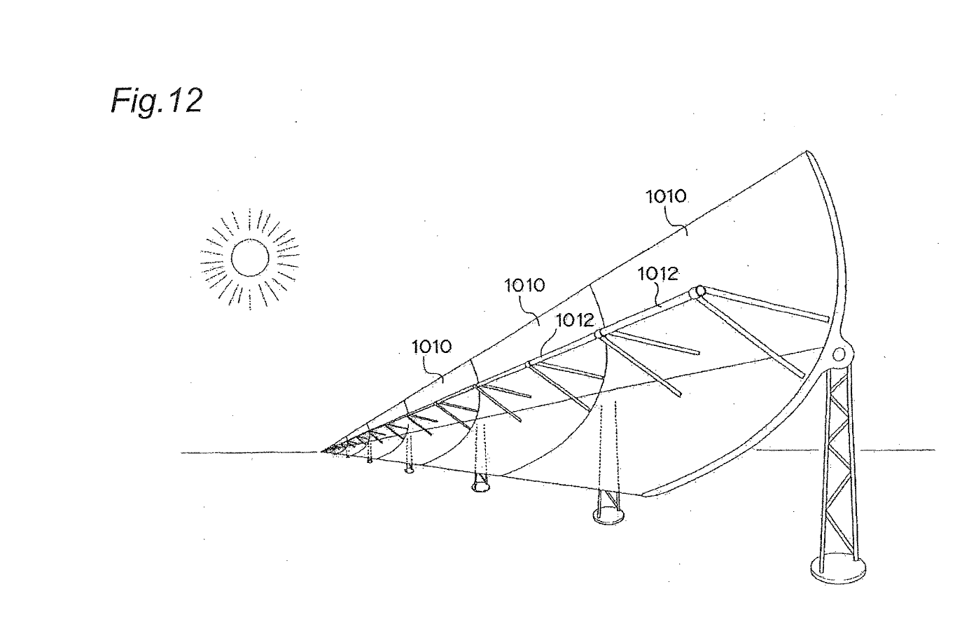

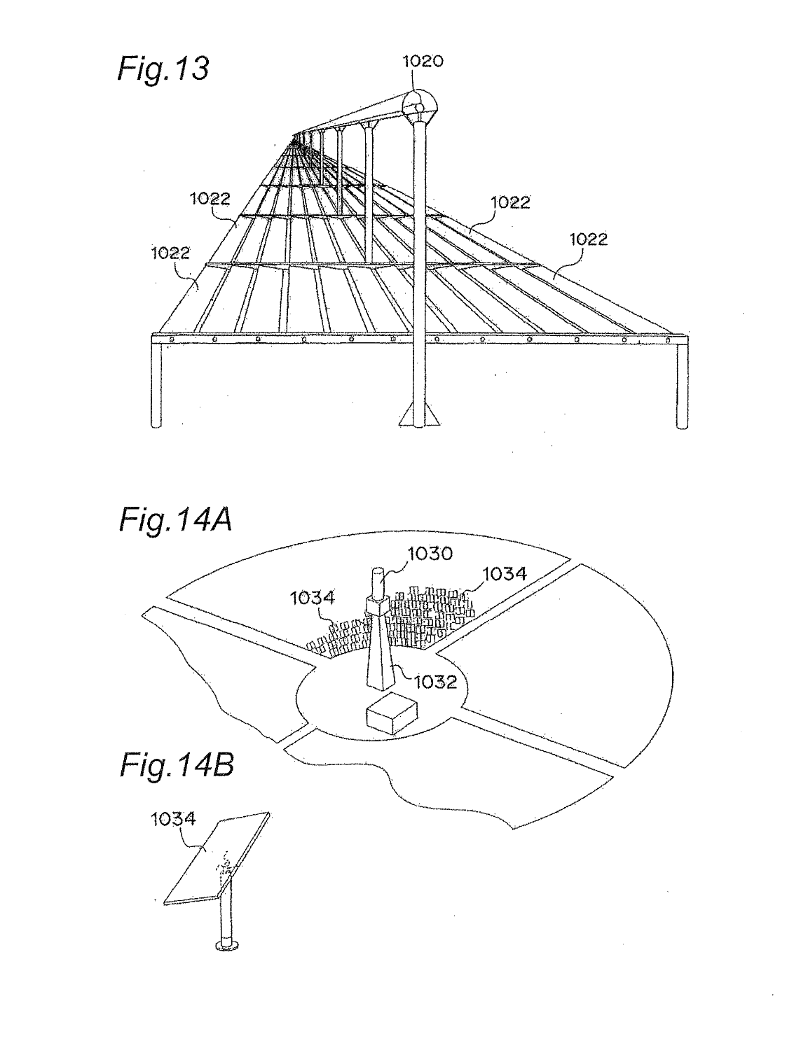

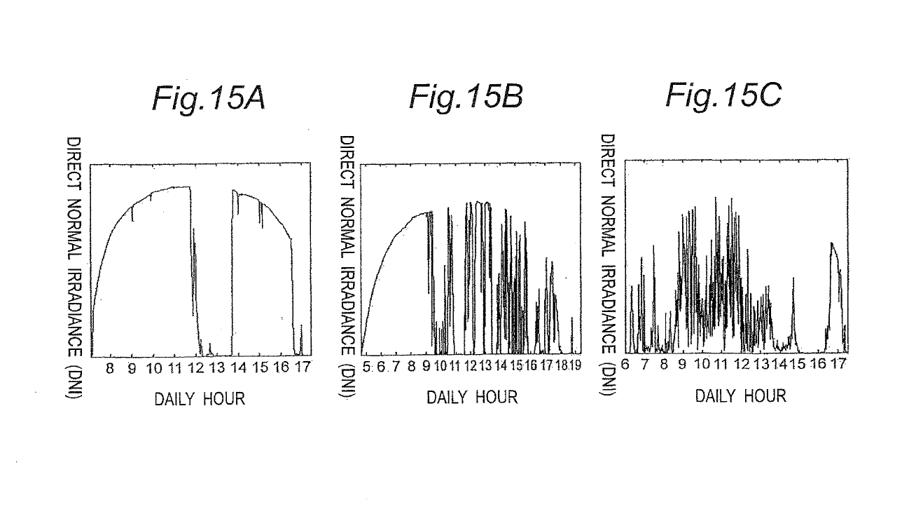

As other heat collecting devices, the parabolic trough type heat collector shown in FIG. 12 have higher efficiency of heat collection than the Fresnel type heat collector 22 and are commonly used for solar thermal electric power generation system with large power output of 30 MW or larger. As oil is usually used as the heating medium, there is a limitation on a temperature for use (namely, approximately 400° C., although the limitation depends on a type of the oil). The manufacturing cost of the parabolic trough type heat collector are higher than that of the Fresnel type heat collector.

The tower type heat collector shown in FIG. 14 has higher efficiency of heat collection than the Fresnel type heat collector 22. In a system in which molten salt is used as the heating medium, the heating medium can be heated to an extremely high temperature (namely, temperature exceeding about 560° C. in use of mixed salt of potassium nitrate and sodium nitrate, for instance, though the temperature depends on a type of the molten salt). The tower type heat collector 1032 requires an earthquake-resistance strength and a high output pump (not being shown) for supplying the heating medium to the top part 1030 of the tower 1032. Accordingly, the manufacturing cost is higher than that of the Fresnel type heat collector.

The Fresnel type heat collector 22 can be configured at a lower cost in comparison with other heat collecting devices but it has lower efficiency of heat collection in comparison with other heat collector devices. In order to increase the heat collecting efficiency of the Fresnel type heat collector 22, the heating device 14 is provided in the integrated solar combined cycle power plant 10.

As shown in FIGS. 1 and 2, the heating medium in vapor phase having been evaporated by the heating of the solar field 12 flows out of the heat absorbing pipes 24 and passes through the heating device 14. The heating device 14 heats the heating medium and increases a proportion of the medium in vapor phase so that a rated steam flow can be supplied to the steam turbine generating device 18. All portion of the heating medium is preferably turned into vapor phase after being heated by the heating device 14. Details of the heating device 14 will be described later.

The heating medium having been heated by the heating device 14 is separated into vapor phase (namely, steam) and liquid phase (namely, water) by a vapor-liquid separating device 26. The heating medium in liquid phase is returned to the solar field 12. The heating medium in vapor phase is supplied to and stored in a vapor storage tank (namely, a buffer tank) 28. The heating medium having changed its phase into liquid phase while being stored in the vapor storage tank 28 is returned to the solar field 12.

The heating medium in vapor phase stored in the vapor storage tank 28 is subsequently controlled by a flow control valve 30 so as to attain the rated steam flow for the steam turbine generating device 18. The heating medium is supplied to the steam turbine generating device 18. The heating medium (namely, steam) drives a steam turbine 18a of the steam turbine generating device 18. The steam turbine 18a drives a generator 18b. The generator 18b generates electric power.

After driving the steam turbine 18a, the heating medium in vapor phase is liquidized by a condenser 32. The liquidized heating medium is sent by a pump 34, heated by a feedwater heater 36, and deaerated by a deaerator 38. The deaerated heating medium is supplied to the solar field 12 by a pump 42.

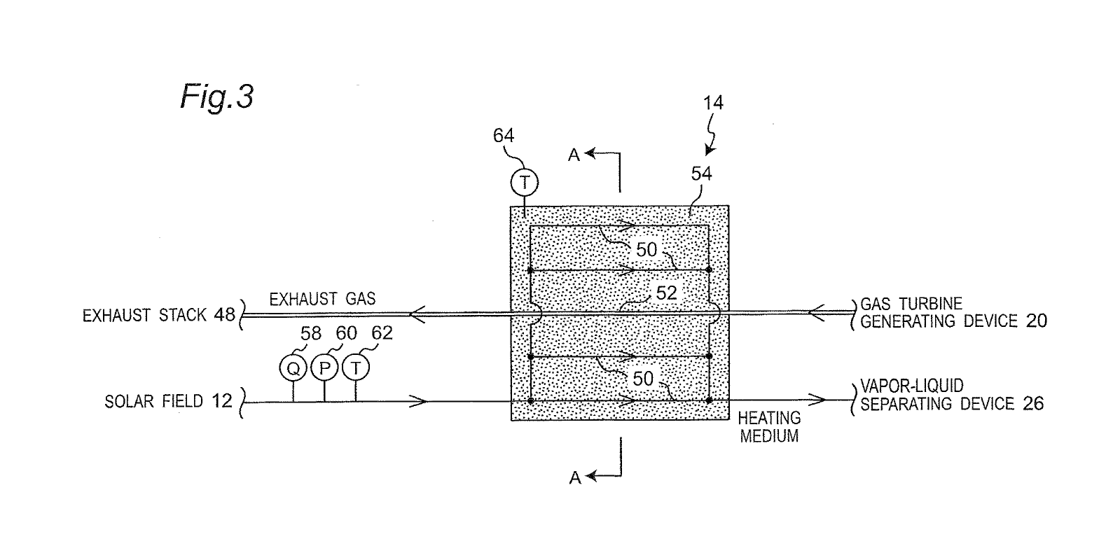

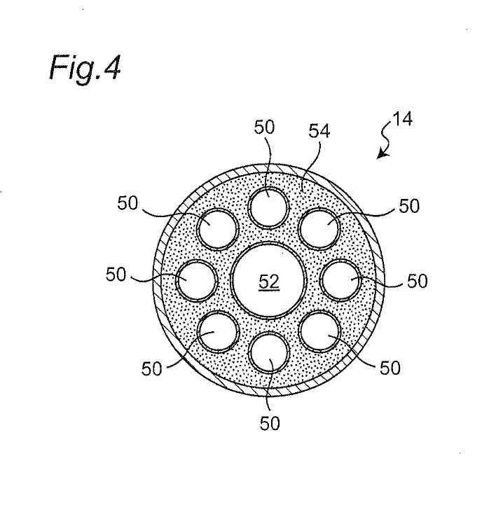

Hereinbelow, details of the heating device 14 will be described. FIG. 3 schematically shows a configuration of the heating device 14. FIG. 4 shows a section (A-A section) of the heating device 14.

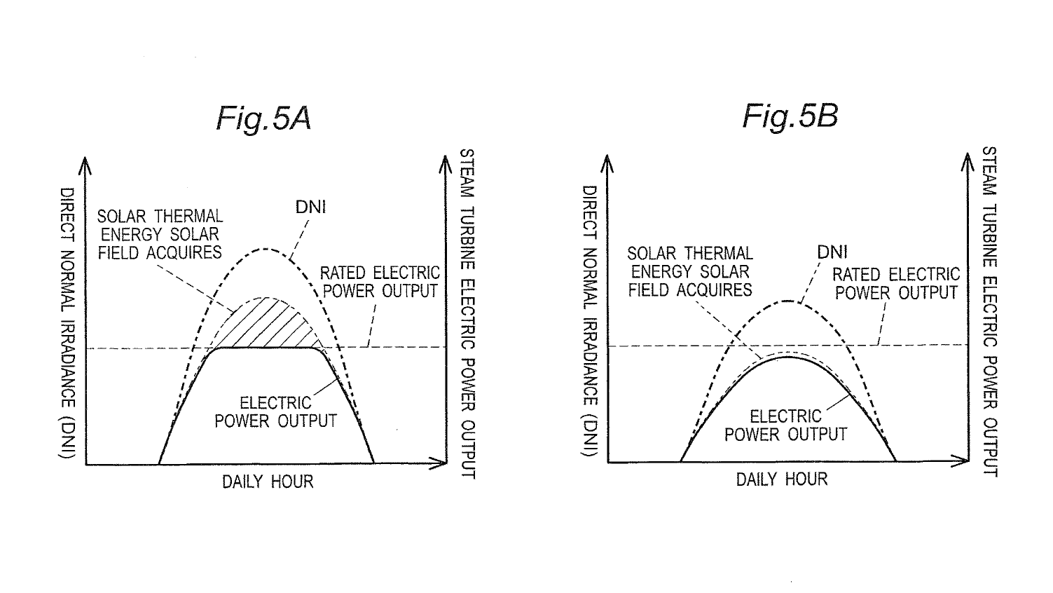

A role of the heating device 14 will be described below. As described above, the rated amount of steam (namely, the heating medium in vapor phase) is required so that the steam turbine generating device 18 can generate the rated electric power. FIGS. 5A-5B show solar thermal energy intensity in one day (shown with chain lines), electric power generation by the steam turbine generating device 18 (shown with solid lines), and solar thermal energy the solar field 12 acquires (shown with two-dot chain lines). As shown in FIG. 5B, the solar thermal energy acquired in the solar field 12 does not completely coincide with the electric power amount that is converted from the thermal energy. The reason is that energy loss is caused by such as copper loss, iron loss, sliding friction and/or the like in the steam turbine generating device 18 during converting the solar thermal energy into the electrical energy.

For planning of the solar thermal electric power generation system, normally, the rated electric power output of the steam turbine generating device 18 is determined on the basis of average direct normal irradiance at a location where the solar field 12 is constructed. The reason is that the maximum direct normal irradiance can be obtained for only a short period of time in one day and that the steam turbine generating device must be operated at a partial load for almost all other periods of time. As efficiency of the steam turbine is decreased in the operation at partial load, efficiency of power generation of the whole electricity generation system is decreased. Therefore, it is rational to determine the rated electric power output of the steam turbine generating device 18 on the basis of the “average direct normal irradiance” rather than the maximum direct normal irradiance. The “average direct normal irradiance” refers to an imaginary constant direct normal irradiance based on an assumption that electric power generation amount, which equals to electric power generation amount attained with use of actual direct normal irradiance that changes in one day, is attained through calculation with use of the imaginary constant direct normal irradiance. In specific steps of a plan, a quantity of the heating medium in vapor phase (namely, steam) produced in the solar field 12 with use of such solar heat that is provided in accordance with the average direct normal irradiance, is calculated as the first step. As the second step, possible electric power generation amount is calculated in accordance with the calculated quantity of the heating medium in vapor phase. Specifications of the steam turbine generating device 18 are determined on the basis of the calculated electric power generation amount.

FIG. 5A shows such a day when the direct normal irradiance through the day exceeds the average direct normal irradiance for some hours. And FIG. 5B shows such a day when the direct normal irradiance through the day is below the average direct normal irradiance.

In case that the direct normal irradiance exceeds the average direct normal irradiance as shown in FIG. 5A, the heating medium coming from the solar field 12 has a relatively larger proportion of vapor phase. Consequently, the rated steam flow or a larger steam flow can be obtained. Although the rated or larger power output can be generated, the steam turbine generating device 18 is operated so that the power output may not exceed the rated power output. That is, a situation occurs in which a hatched portion of the solar thermal energy is not effectively utilized.

In case that the direct normal irradiance in one day is lower than the average direct normal irradiance as shown in FIG. 5B, the heating medium coming from the solar field 12 has a relatively smaller proportion of vapor phase. That is, the rated steam flow cannot be obtained. Therefore, such a situation occurs that the power output of the steam turbine generating device 18 does not reach the rated power output.

In consideration of these facts, the heating device 14 is configured so as to heat the heating medium having been heated by solar heat (namely, by the solar field 12), by the exhaust gas from the gas turbine generating device 20. As the result, the steam turbine generating device 18 is capable of stably generating the rated electric power without dumping the solar thermal energy. The heating device 14 is provided in order to assist the Fresnel type heat collector 22 having lower efficiency of heat collection than other heat collecting devices.

As shown in FIGS. 3 and 4, the heating device 14 has heating medium channels (namely, first channels) 50 through which the heating medium passes from the solar field 12 to the vapor-liquid separating device 26, an exhaust gas channel (namely, second channel) 52 through which the hot exhaust gas passes after being discharged from the gas turbine generating device 20, and heating material 54 capable of storing heat.

The heating medium channels 50 and the exhaust gas channel 52 are made of, for example, steel pipes capable of performing efficient heat exchanging between internal spaces of the channels where the heating medium and the exhaust gas are flowing and outside of the spaces. FIG. 4 shows the channels in shape of cylinders and circular arrangement of the channels, but shapes and arrangement of the channels are not limited to these.

The heating material 54 that absorbs and stores heat from other objects and that supplies the stored heat to other objects are such as concrete, sand, molten salt, and ceramics but is not limited to these. The heating material 54 may be gas such as sealed air.

As shown in FIG. 4, the heating material 54 is directly and thermally connected to the heating medium channels 50 or the heating medium. The heating material 54 is also directly and thermally connected to the exhaust gas channel 52 or the exhaust gas. Thus, the heating material 54 is capable of absorbing and storing heat from the heating medium or the exhaust gas and capable of heating the heating medium by the stored heat by supplying the heat to the heating medium. That is, the exhaust gas and the heating medium are indirectly and thermally connected to each other through the heating material 54.

The integrated solar combined cycle power plant 10 is configured so that electric power output of the gas turbine generating device 20 can be controlled and a quantity of the exhaust gas supplied into the exhaust gas channel 52 can be regulated on the basis of a quantity of the heating medium in vapor phase that flows from the solar field 12 into the heating medium channels 50.

A flow measuring device 58, a pressure measuring device 60, and a temperature measuring device 62 are provided in order to measure the quantity of the heating medium in vapor phase that flows into the heating medium channels 50. The quantity of the heating medium in vapor phase that flows into the heating medium channels 50 is calculated on the basis of a flow rate of the heating medium measured by the flow measuring device 58, a pressure of the heating medium measured by the pressure measuring device 60, and a temperature of the heating medium measured by the temperature measuring device 62.

The calculation of the quantity of the heating medium in vapor phase that flows into the heating medium channels 50 in the heating device 14 and the control of the gas turbine generating device 20 on the basis of the calculated result are carried out by a main computer (not being shown) of the integrated solar combined cycle power plant 10. The main computer controls many devices such as the steam turbine generating device 18, the gas turbine generating device 20, the condenser 32, the deaerator 38, the flow control valve 30, the pumps 34, 42 and the like.

The heating device 14 is configured so as to absorb the retained heat in the heating medium by the heating material 54 in case that the quantity of the heating medium in vapor phase supplied from the solar field 12 is larger than a specified quantity. The heating device 14 is configured so as to heat the heating medium by the stored heat in the heating material 54 in case that the quantity of the heating medium in vapor phase is smaller than the specified quantity. Herein, “specified quantity” of the heating medium in vapor phase is such a quantity that is calculated on the basis of a quantity that is lost before arriving at the steam turbine generating device 18 and a rated quantity.

In the embodiment, the quantity of the exhaust gas supplied into the exhaust gas channel 52 is regulated by controlling the electric power output of the gas turbine generating device 20 so that the temperature of the heating material 54 may be kept constant at a specified temperature (namely, a temperature corresponding to a specified quantity of the stored heat). The specified temperature is preferably set at such a temperature that heat dose not transfer from the heating medium to the heating material 54 in case that the quantity of the heating medium in vapor phase flowing through the heating medium channels 50 is nearly as large as the specified quantity. For that purpose, a temperature measuring device 64 for detecting the temperature of the heating material 54 is provided in the heating device 14. The temperature measuring device 64 may be provided at any location in the heating device 14 on condition that a temperature correlated with the temperature (namely, the quantity of the retained heat) of the heating material 54 can be measured.

In case that the quantity of the heating medium in vapor phase flowing through the heating medium channels 50 exceeds the specified quantity while that the heating material 54 is kept having the specified constant temperature, the quantity of the exhaust gas supplied into the exhaust gas channel 52 is decreased by lowering or interrupting electric power generation of the gas turbine generating device 20. As the result, the quantity of the retained heat in the heating material 54 is decreased so that a portion of the retained heat in the heating medium can be absorbed by the heating material 54. In case that the quantity of the heating medium in vapor phase falls below the specified quantity, the supplied quantity of the exhaust gas is increased by increasing or re-starting electric power generation of the gas turbine generating device 20. As the result, the quantity of the retained heat in the heating material 54 is increased so that a portion of the retained heat in the heating material 54 can be supplied to the heating medium. Thus, the quantity of the heating medium in vapor phase coming out from the heating device 14 can be kept at the specified quantity.

When an operation of the integrated solar combined cycle power plant 10 is started, the exhaust gas may be supplied into the exhaust gas channel 52 by controlling the gas turbine generating device 20 for a purpose of increasing the quantity of the retained heat in the heating material 54 or for a purpose of warming the heating medium channels 50 and the exhaust gas channel 52 (namely, a purpose of warming the heating device 14).

Hereinbelow, advantages of the heating device 14 will be described.

In one advantage, the heating medium in vapor phase can sufficiently and stably be supplied to the steam turbine generating device 18 by additional heating of the heating device 14. That is, the heating device 14 additionally heats the heating medium having been heated insufficiently by the solar field 12 in such cases as short hours of sunlight, low direct normal irradiance, and/or sharp change in direct normal irradiance. As the result, the steam turbine generating device 18 is capable of generating sufficient electric power. A heat source for heating the heating medium is the exhaust gas discharged from the gas turbine generating device 20, and thus the electric power that the gas turbine generating device 20 generates in producing the exhaust gas can be used as the power output of the integrated solar combined cycle power plant 10. Owing to an effect of those, availability of solar thermal energy is increased. For instance, it is not necessary to stop an operation of the integrated solar combined cycle power plant 10 even in the case that direct normal irradiance intensity is low.

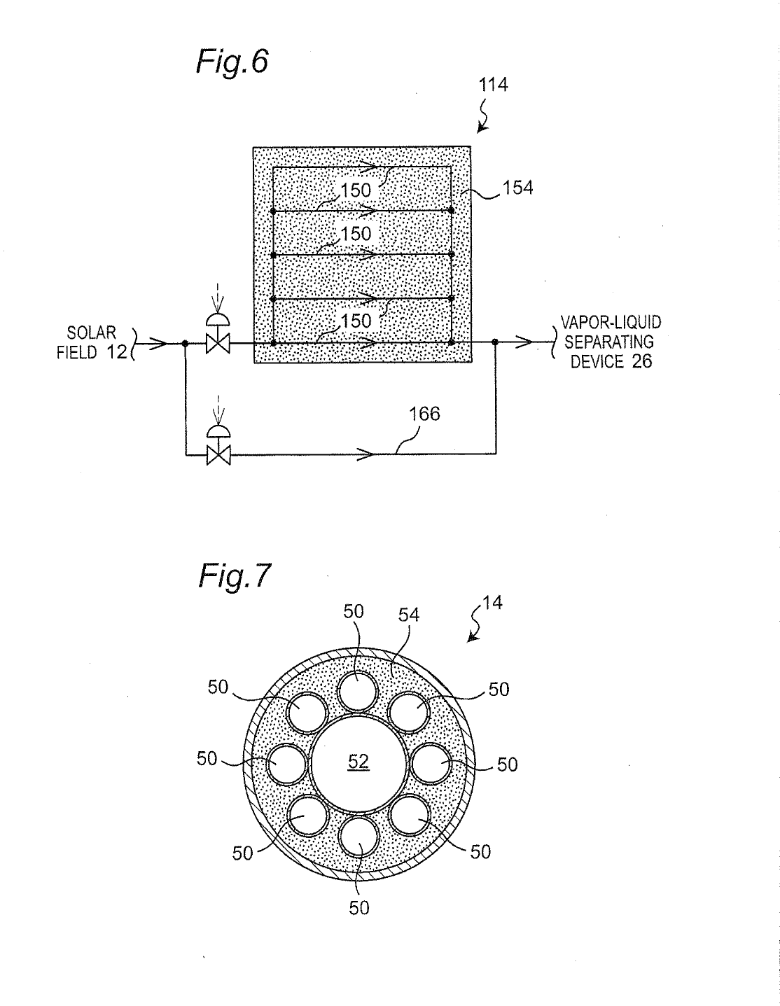

In another advantage, the quantity of the heating material 54 can be decreased. For specific description of this advantage, FIG. 6 shows a comparative example of a heating device that heats the heating medium, being supplied from the solar field, only by a heating material without using an exhaust gas.

In the heating device 114 of the comparative example shown in FIG. 6, in case that a quantity of stored heat in the heating material 154 is near a lower limit and that a quantity of the heating medium in vapor phase being supplied from the solar field 12 is nearly as large as a specified quantity, it is necessary to provide a bypass channel 166 through which the heating medium flows without thermal connection to the heating material 154.

In the heating device 14 of the embodiment 1 of FIGS. 2 and 3, the temperature (namely, the quantity of the retained heat) of the heating material 54 is kept constant by the exhaust gas, and thus the heat of the heating medium is not largely absorbed by the heating material 54.

In the heating device 114 of the comparative example, in case that the quantity of the stored heat in the heating material 154 is near the lower limit and that the quantity of the heating medium in vapor phase being supplied from the solar field 12 falls below the specified quantity, the heating medium cannot be heated by the stored heat in the heating material 154. Accordingly, the electric power amount from the steam turbine generating device 18 is decreased. Therefore, a large quantity of heating material 154 is required.

In the heating device 14 of the embodiment 1 of FIGS. 2 and 3, it is possible to heat the heating medium not only because the temperature (namely, the quantity of the stored heat) of the heating material 54 is kept constant by the exhaust gas of the gas turbine but also because the quantity of the exhaust gas supplied into the exhaust gas channel 52 can be increased by increasing the power generation of the gas turbine generating device 20.

In the heating device 114 of the comparative example, in case that the quantity of the stored heat in the heating material 54 is near the upper limit and that the quantity of the heating medium in vapor phase being supplied from the solar field 12 exceeds the specified quantity, the heating material 154 can not absorb the heat of the heating medium. The heating device 114 of the comparative example is configured so as to heat the heating medium by the stored heat in the heating material 154, and thus the heating material 154 is thermally isolated from outside (namely, spontaneous heat dissipation from the heating material 154 is suppressed). Therefore, a large quantity of heating material 154 is required.

In the heating device 14 of the embodiment 1, in case that the quantity of the retained heat in the heating material 54 is near the upper limit and that the quantity of the heating medium in vapor phase being supplied from the solar field 12 exceeds the specified quantity, the supply of the exhaust gas into the exhaust gas channel 52 is stopped by stopping the gas turbine. As the result, the heat of the heating medium can be absorbed by the heating material 54 by decreasing the quantity of the stored heat in the heating material 54. That is, the stoppage of the supplying the exhaust gas result in that a portion of the stored heat in the heating material 54 transfers into the exhaust gas channel 52 and diffuses in the air through a exhaust stack 48.

In consideration of these facts, the bypass channel 166 and the large quantity of heating material 154 are required in the heating device 114 of the comparative example. Besides, a large container is required for containing the large quantity of heating material 154. This increases the manufacturing cost.

The heating device 14 of the embodiment 1 does not require a large quantity of heating material 54 and thus realizes lower manufacturing cost.

The invention may include any bypass channel for avoiding heat exchange between the heating medium and the heating material 54. In case that the specified quantity of the heating medium in vapor phase is frequently supplied from the solar field 12, the heating device 14 preferably includes the bypass channel.

As shown in FIG. 7, the heating medium channels 50 (namely, the heating medium) and the exhaust gas channel 52 (namely, the exhaust gas) may directly and thermally be connected to each other so that the heating medium can directly be heated by the exhaust gas. This configuration makes it possible to attain quicker response to sharp change in direct normal irradiance (namely, sharp change in the quantity of the heating medium in vapor phase) than in such a configuration that the heating medium is indirectly heated through the heating material 54 by the exhaust gas as shown in FIG. 4. In case that the quantity of the heating medium in vapor phase flowing through the heating medium channels 50 is sharply decreased by sudden change in weather, for instance, the quantity of the exhaust gas supplied into the exhaust gas channel 52 can be increased by increasing the power output of the gas turbine generating device 20 so that the heating medium can quickly be heated by a portion of the retained heat in the exhaust gas (namely, the heat that transfers into the heating medium channels 50).

As shown in FIG. 3, the quantity of the heating medium in vapor phase is calculated on the basis of results of measurement by such measuring devices as the flow measuring device 58, the pressure measuring device 60, and the temperature measuring device 62 before the heating medium flows into the heating medium channels 50, namely, before the heat exchange is performed between the heating medium and the heating material 54. In this arrangement, the regulating steps the quantity of the exhaust gas, which is supplied into the exhaust gas channel 52 (namely, the control of the gas turbine generating device 20), are subjected to feedforward control on the basis of the quantity of the heating medium in vapor phase. Alternatively, the quantity of the heating medium in vapor phase may be measured after its flowing out of the heating medium channels 50, namely, after the heat exchange between the heating medium and the heating material 54. In this arrangement, the regulation of the quantity of the exhaust gas, which is supplied into the exhaust gas channel 52 (namely, the control of the gas turbine generating device 20), on the basis of the quantity of the heating medium in vapor phase is subjected to feedback control. The feedforward control and the feedback control can be performed in combination. As the result, the quantity of the exhaust gas can accurately be regulated.

The quantity of the heating medium in vapor phase is measured and calculated for the regulating the quantity of the exhaust gas supplied into the exhaust gas channel 52 of the heating device 14 (namely, for the control of the gas turbine generating device 20), whereas the invention is not limited to these. The quantity of the exhaust gas, which is supplied into the exhaust gas channel 52, can be regulated on the basis of a result of measurement of the quantity of the heating medium in liquid phase. A flow measuring device 68 for measuring the quantity of the heating medium in liquid phase separated by the vapor-liquid separating device 26 is provided as shown in FIG. 2, for instance, and the power generation of the gas turbine generating device 20 (namely, the quantity of the exhaust gas supplied into the exhaust gas channel 52) is regulated on the basis of the quantity of the heating medium in liquid phase measured by the flow measuring device 68. In case that the quantity of the heating medium in liquid phase measured by the flow measuring device 68 increases, for instance, the power output of the gas turbine generating device 20 is increased and the quantity of the exhaust gas supplied into the exhaust gas channel 52 is increased. In case that the quantity of the heating medium in liquid phase measured by the flow measuring device 68 decreases, the power output of the gas turbine generating device 20 is decreased and the quantity of the exhaust gas supplied into the exhaust gas channel 52 is decreased.

Concerning to the flow measuring device 68, the supply of the exhaust gas into the exhaust gas channel 52 in the heating device 14 may be stopped by stopping the gas turbine generating device 20 in case that the quantity of the heating medium in liquid phase measured by the flow measuring device 68 is nearly as large as the quantity of the heating medium in liquid phase before being heated by the solar field 12 (namely, the quantity of the heating medium that a pump 42 supplies to the solar field 12). There is a reason why the quantity of the heating medium in liquid phase measured by the flow measuring device 68 is nearly as large as the quantity of the heating medium in liquid phase before heating by the solar field 12. The reason is that the quantity of the heating medium in vapor phase can not be increased because of low direct normal irradiance, even after heating the heating medium by using the heating device 14.

The quantity of the heating medium in liquid phase supplied to the solar field 12 (namely, the quantity of the heating medium that the pump 42 supplies to the solar field 12) may be regulated on the basis of the quantity of the heating medium in liquid phase measured by the flow measuring device 68. In case that the quantity of the heating medium in liquid phase measured by the flow measuring device 68 increases, for instance, the quantity of the heating medium in liquid phase supplied through the pump 42 to the solar field 12 is decreased. In case that the quantity of the heating medium in liquid phase measured by the flow measuring device 68 decreases, the quantity of the heating medium in liquid phase supplied through the pump 42 to the solar field 12 is increased. Thus, the heating device 14 is capable of fully achieving its heating ability. That is, supply to the heating device 14 a large quantity of heating medium in liquid phase that exceeds the heating ability (namely, the ability to evaporate the heating medium in liquid phase) of the heating device 14. And the heating medium in liquid phase in such an optimum quantity that the heating device 14 can sufficiently be utilized is supplied to the heating device 14.

Concerning to the pump 42, the pump 42 preferably starts to supply the heating medium in liquid phase to the solar field 12 when temperatures of the heat absorbing pipes 24 of the solar field 12 become high enough. In case that the temperatures of the heat absorbing pipes 24 is not high enough to change the phase of the heating medium from liquid phase to vapor phase, a large quantity of heating medium in liquid phase will flow without changing to vapor phase, from the heat absorbing pipes 24 to the heating device 14, and thus the heating device 14 will be cooled. As the result, the heat that the heating material 54 of the heating device 14 stores will be taken away.

Therefore, the pump 42 is controlled so that the supply of the heating medium in liquid phase to the solar field 12 may be started when solar heat (namely, the reflected light from the mirrors 22a) heats up the heat absorbing pipes 24 hot enough. For instance, the pump 42 starts to supply the heating medium in liquid phase to the solar field 12 when the temperature measured in the heat absorbing pipes 24 and the temperature measured in the heating device 14 become nearly equal. This suppresses cooling down of the heating device 14 because of supplying a large quantity of heating medium in liquid phase.

As shown in FIG. 2, a relief valve 44 for discharging the exhaust gas through the exhaust stack 48 into the air may be provided between the gas turbine generating device 20 and the heating device 14. For instance, there is a case that the electric power generated by the gas turbine generating device 20 is additionally required while the steam turbine generating device 18 is generating the rated electric power. When the steam turbine generating device 18 generating a rated electric power, supply of the exhaust gas from the gas turbine generating device 20 to the heating device 14 will lead to overheating of the heating medium that has sufficiently been heated by the solar field 12. In order to prevent this, the relief valve 44 may be provided so as to adjust the quantity of the exhaust gas supplied from the gas turbine generating device 20 to the heating device 14. Thus, the integrated solar combined cycle power plant 10 is capable of producing the sum of the rated electric power generated by the steam turbine generating device 18 and the other rated electric power generated by the gas turbine generating device 20.

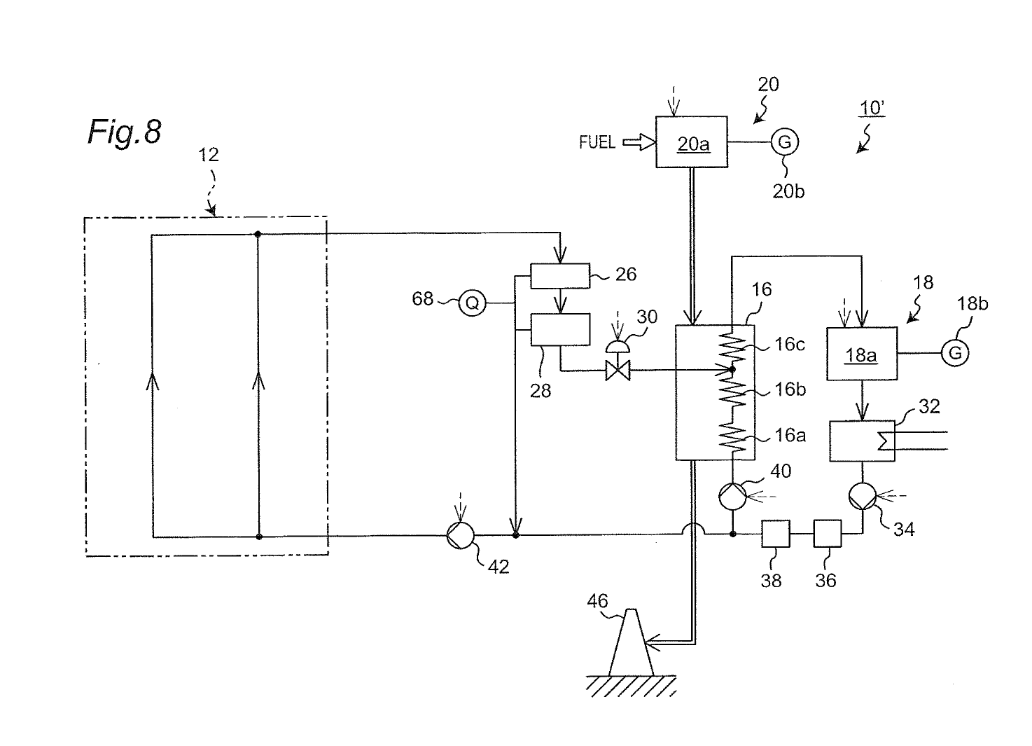

Hereinbelow, advantages of the integrated solar combined cycle power plant 10 of the embodiment 1 will be described in comparison with an integrated solar combined cycle power plant of a similar comparative example. FIG. 8 shows a configuration of the integrated solar combined cycle power plant 10′ of the comparative example.

The integrated solar combined cycle power plant 10′ of the comparative example shown in FIG. 8 has generally the same component elements as the integrated solar combined cycle power plant 10 of the embodiment 1 shown in FIG. 2, except for the heating device 14. In substitution for the heating device 14, the integrated solar combined cycle power plant 10′ of the comparative example has an exhaust heat recovery boiler device 16 which the integrated solar combined cycle 10 power plant of the embodiment 1 does not have.

The exhaust heat recovery boiler device 16 includes an economizer (preheater) 16a, an evaporator 16b, and a superheater 16c and is configured so as to heat (namely, to superheat) the heating medium in vapor phase that has been separated by the vapor-liquid separating device 26 by using the exhaust gas from the gas turbine generating device 20.

Specifically, the heating medium supplied from the vapor storage tank 28 to the exhaust heat recovery boiler device 16 mixes with the heating medium having been evaporated by the evaporator 16b and then flows into the superheater 16c. The heating medium (namely, superheated steam) superheated by the superheater 16c is supplied to the steam turbine 18a.

A portion of the heating medium deaerated by the deaerator 38 is supplied to the exhaust heat recovery boiler device 16 by a pump 40, is preheated by the economizer (namely, preheater) 16a, is evaporated by the evaporator 16b, and mixes with the heating medium supplied from the vapor storage tank 28.

As a heat source for preheating, evaporating, and superheating the heating medium in liquid phase, the exhaust gas discharged from the gas turbine 20a of the gas turbine generating device 20 is supplied to the exhaust heat recovery boiler device 16.

The exhaust gas supplied from the gas turbine generating device 20 to the exhaust heat recovery boiler device 16 is finally discharged in the air through the exhaust stack 46.

The integrated solar combined cycle power plant 10′ of the comparative example shown in FIG. 8, having such an exhaust heat recovery boiler device 16, increases the manufacturing cost in comparison with the integrated solar combined cycle power plant 10 of the embodiment 1.

The gas turbine generating device 20 of the comparative example is required to be operated continuously while the integrated solar combined cycle power plant 10′ is running, because the exhaust gas needs to be supplied continuously to the exhaust heat recovery boiler device 16. That is, in case of stopping the supply of the exhaust gas from the gas turbine generating device 20 to the exhaust heat recovery boiler device 16, the heating medium in vapor phase supplied from the vapor-liquid separating device 26 will be cooled by the heating medium in liquid phase supplied from the deaerator 38. Consequently, this makes it impossible to supply a sufficient quantity of heating medium in vapor phase to the steam turbine generating device 18 and causes stoppage of the electric power generation of the steam turbine generating device 18. Therefore, the gas turbine generating device 20 of the comparative example is required to be operated continuously.

In the integrated solar combined cycle power plant 10′ of the comparative example, the heating device 14 for heating the heating medium as in the embodiment 1 is not provided between the solar field 12 and the liquid separator device 26. Therefore, in order to stably supply the heating medium in vapor phase from the solar field 12 through the vapor-liquid separating device 26 to the steam turbine generating device 18, there is no choice but to apply the heat collecting device having higher efficiency of heat collection, such as the expensive parabolic trough type heat collector or the expensive tower type heat collector.

The integrated solar combined cycle power point 10′ of the comparative example lacks the heating device 14 but includes the exhaust heat recovery boiler device 16 and the expensive heat collecting device having higher efficiency of heat collection, and thus increases manufacturing cost in comparison with the integrated solar combined cycle power plant 10 of the embodiment 1.

Although including the parabolic trough type heat collector having higher efficiency of heat collection, the integrated solar combined cycle power plant 10′ of the comparative example is not capable of supplying the sufficient quantity of heating medium in vapor phase to the steam turbine generating device 18 in such case as short hours of available sunlight, low direct normal irradiance, and/or sharp change in direct normal irradiance. On the other hand, the integrated solar combined cycle power plant 10 of the embodiment 1 includes the heating device 14 and is capable of supplying the sufficient quantity of heating medium in vapor phase to the steam turbine generating device 18 even in such cases as short hours of available sunlight, low direct normal irradiance, and/or sharp change in direct normal irradiance.

In the embodiment 1, the heating medium can sufficiently be heated by using the inexpensive configuration even in such cases as short hours of sunlight, low direct normal irradiance, and/or sharp change in direct normal irradiance. Besides, the heating medium can sufficiently be evaporated, and consequently a sufficient quantity of heating medium in vapor phase can be supplied to the steam turbine generating device 18. As the result, the steam turbine generating device 18 (namely, the integrated solar combined cycle power plant 10) is capable of generating sufficient electric power.

### Embodiment 2

An integrated solar combined cycle power plant in accordance with an embodiment 2 is the same as that of the embodiment 1 except for a heating device. Hereinbelow, the heating device in accordance with the embodiment 2 will be described.

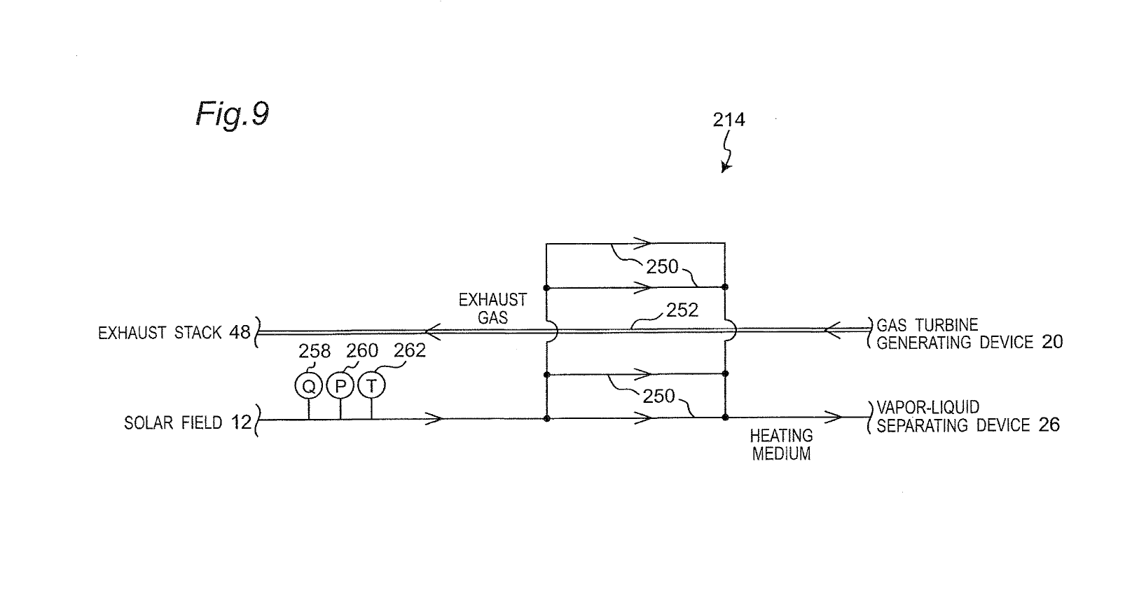

FIG. 9 shows the heating device 214 of the embodiment 2. Unlike the heating device 14 of the embodiment 1, the heating device 214 of the embodiment 2 has no heating material. Heating medium channels 250 (namely, heating medium) and an exhaust gas channel 252 (namely, exhaust gas) are thermally connected to each other.

In the heating device 214 of the embodiment 2, in case that a quantity of the heating medium in vapor phase supplied from the solar field 12 (namely, a quantity of the heating medium in vapor phase calculated on the basis of results of measurements by a flow measuring device 258, by a pressure measuring device 260, and by a temperature measuring device 262) exceeds a specified quantity, a quantity of the exhaust gas supplied into the exhaust gas channel 252 is decreased by decreasing the power output of the gas turbine generating device 20, or supply of the exhaust gas is stopped by stopping power generation. While the heating medium flows through the heating medium channels 250, a portion of retained heat therein enters the exhaust gas channel 252 and diffuses in the air through the exhaust stack 48.

In case that the quantity of the heating medium in vapor phase supplied from the solar field 12 is below the specified quantity, on the basis of the quantity of the heating medium in vapor phase, a quantity of the exhaust gas supplied into the exhaust gas channel 252 is increased by increasing power output of the gas turbine generating device 20 or the supply of the exhaust gas is resumed by resuming power generation of the gas turbine generating device 20.

The heating device 214 of the embodiment 2 has no heating material and is made more compact than the heating device 14 of the embodiment 1. As there is no heating material, the device can not absorb nor keep stored heat in the heating medium. Therefore, it is impossible to absorb and store a portion of the retained heat in the heating medium by heating material in case that the quantity of the heating medium in vapor phase being supplied from the solar field 12 exceeds the specified quantity. And, it is impossible to use stored heat in the heating material for heating the heating medium.

In case that the specified quantity of the heating medium in vapor phase is frequently supplied from the solar field 12, the heating device 214 preferably includes a bypass channel thermally isolated from the exhaust gas channel 252.

### Embodiment 3

An integrated solar combined cycle power plant in accordance with an embodiment 3 is the same as that of the embodiment 1 except for a heating device. Hereinbelow, the heating device in accordance with the embodiment 3 will be described.

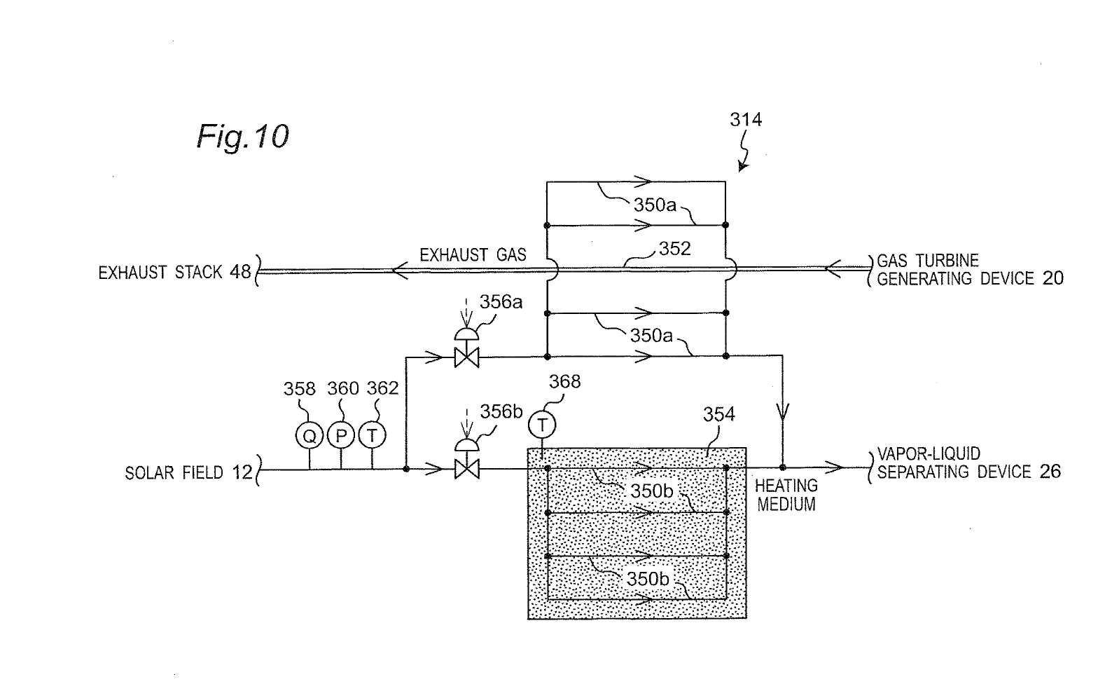

FIG. 10 shows the heating device 314 of the embodiment 3. In the heating device 314 of the embodiment 3, unlike the heating device 14 of the embodiment 1, heating material 354 and an exhaust gas channel 352 (namely, an exhaust gas) are thermally isolated from each other. That is, heat is not exchanged between the heating material 354 and the exhaust gas.

For that reason, the heating device 314 has heating medium channels 350a thermally connected only to the exhaust gas channel 352, heating medium channels 350b thermally connected only to the heating material 354, and flow control valves 356a, 356b for supplying heating medium to at least either the heating medium channels 350a or the heating medium channels 350b.

For the heating device 314 of the embodiment 3, the gas turbine generating device 20 is controlled on the basis of a quantity of the heating medium in vapor phase being supplied from the solar field 12. The quantity of the heating medium is calculated on the basis of results of measurements by a flow measuring device 358, by a pressure measuring device 360, and by a temperature measuring device 362, and a result of measurements by a temperature measuring device 368 (namely, a quantity of stored heat in the heating material 354). As the result, a quantity of the exhaust gas supplied into the exhaust gas channel 352 is regulated and flow control valves 356a, 356b are so controlled.

In case that the quantity of the heating medium in vapor phase being supplied from the solar field 12 is below a specified quantity, a portion of the heating medium is supplied into the heating medium channels 350a so as to be heated by the exhaust gas, and the other portion of the heating medium is supplied into the heating medium channels 350b so as to be heated by the heating material 354.

The heating device 314 having such a configuration is capable of accurately controlling a quantity of the heating medium in vapor phase to be supplied to the vapor-liquid separating device 26.

In case that the specified quantity of the heating medium in vapor phase is frequently supplied from the solar field 12, the heating device 314 preferably includes a bypass channel thermally isolated from the exhaust gas channel 352 and the heating material 354.

### Embodiment 4

An integrated solar combined cycle power plant of an embodiment 4 is the same as that of the embodiment 1 except for a heating device. Hereinbelow, the heating device in accordance with the embodiment 4 will be described.

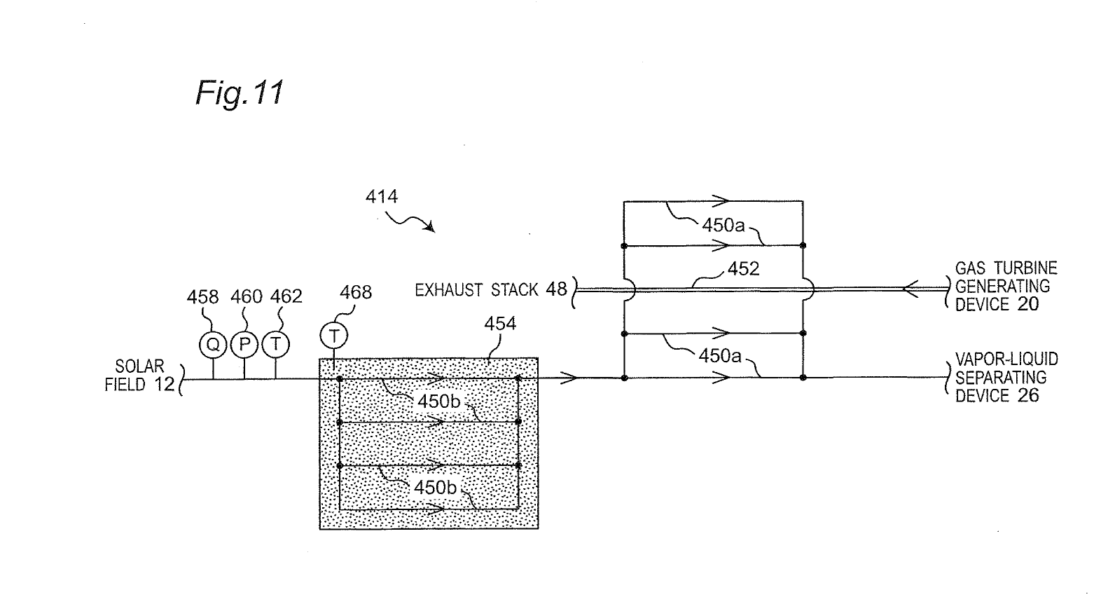

FIG. 11 shows the heating device 414 of the embodiment 4. In the heating device 414 of the embodiment 4, unlike the heating device 14 of the embodiment 1, heating material 454 and an exhaust gas channel 452 (namely, an exhaust gas) are thermally isolated from each other. Heat is not exchanged between the heating material 454 and the exhaust gas.

The heating device 414 has heating medium channels 450a thermally connected only to the exhaust gas channel 452, and heating medium channels 450b thermally connected only to the heating material 454. The heating device 414 is configured so that heating medium having passed through the heating medium channels 450b inevitably flows through the heating medium channels 450a (namely, the heating device 414 is different from the embodiment 3 in this regard).

In the heating device 414 of the embodiment 4, a quantity of the exhaust gas supplied into the exhaust gas channel 452 is regulated by controlling the gas turbine generating device 20 on the basis of a quantity of the heating medium in vapor phase being supplied from the solar field 12. The quantity of the heating medium in vapor phase is calculated on the basis of results of measurements by a flow measuring device 458, by a pressure measuring device 460, and by a temperature measuring device 462, and a result of measurements by a temperature measuring device 468 (namely, a quantity of stored heat in the heating material 454).

In case that the quantity of the heating medium in vapor phase being supplied from the solar field 12 is below a specified quantity, the heating medium is heated by the heating material 454 while the heating medium passes through the heating medium channels 450b, and is subsequently heated by the exhaust gas flowing through the exhaust gas channel 452 while the heating medium passes through the heating medium channels 450a.

The heating device 414 having such a configuration is capable of accurately controlling a quantity of the heating medium in vapor phase being supplied to the vapor-liquid separating device 26. A structure of the heating device 414 of the embodiment 4 is simpler than that of the heating device 314 of the embodiment 3.

In case that the specified quantity of the heating medium in vapor phase is frequently supplied from the solar field 12, the heating device 414 preferably includes a bypass channel thermally isolated from the exhaust gas channel 452 as well as a bypass channel thermally isolated from the heating material 454.

Although the present invention has been fully described in connection with the preferred embodiments with reference to the accompanying drawings, it is to be noted that various changes and modifications are apparent to those skilled in the art. Such Changes and modifications are to be understood as included within the scope of the present invention as defined by the appended claims unless they depart therefrom.

### INDUSTRIAL APPLICABILITY

The invention can be applied to any solar thermal electric power generation system and any solar thermal electric power generation method by which electric power is generated with utilization of heating medium heated by solar heat. The heating medium supplying devices and the heating medium heating devices in accordance with the invention can be applied to any system that requires heating medium in vapor phase. For instance, the heating medium in vapor phase that is obtained from the heating medium supplying devices and the heating medium heating devices in accordance with the invention can be used as a driving source for a turbo-compressor for producing compressed air or as a heat source for a drier.

### REFERENCE SIGNS LIST

10 solar thermal electric power generation system (integrated solar combined cycle power plant)
14 heating device
18 turbine generating device (steam turbine generating device)
20 gas turbine generating device
22 Fresnel type heat collector
50 first channel (heating medium channel)
52 second channel (exhaust gas channel)

1. A solar thermal electric power generation system using heating medium that undergoes phase change between liquid phase and vapor phase, the solar thermal electric power generation system comprising:
Fresnel type heat collectors for heating the heating medium by solar thermal energy,
a gas turbine generating device for generating electric power while discharging exhaust gas,
a heating device comprising a first channel through which the heating medium having been heated by the Fresnel type heat collectors flows and a second channel which is located near the first channel and through which the exhaust gas from the gas turbine generating device flows, the heating device for heating the heating medium in the first channel by the exhaust gas in the second channel,
a vapor-liquid separating device for separating the heating medium having been heated by the heating device into vapor phase and liquid phase, and
a turbine generating device driven by the heating medium in vapor phase separated by the vapor-liquid separating device.

2. The solar thermal electric power generation system according to claim 1, further comprising a gas quantity measuring device for measuring a quantity of the heating medium in vapor phase, wherein
a quantity of the exhaust gas supplied into the second channel of the heating device is regulated by controlling power output of the gas turbine generating device on the basis of the quantity of the heating medium in vapor phase measured by the gas quantity measuring device.

3. The solar thermal electric power generation system according to claim 2, wherein the gas turbine generating device is stopped in case that the quantity of the heating medium in vapor phase measured by the gas quantity measuring device exceeds a specified quantity.

4. The solar thermal electric power generation system according to claim 1, further comprising a supplying device for supplying the heating medium in liquid phase to the Fresnel type heat collectors, wherein
the gas turbine generating device is stopped in case that a quantity of the heating medium in liquid phase that the supplying device supplies to the Fresnel type heat collectors is nearly as large as a quantity of the heating medium in liquid phase separated by the vapor-liquid separating device.

5. The solar thermal electric power generation system according to claim 1, further comprising a temperature measuring device for measuring an inside temperature of the heating device, wherein
a quantity of the exhaust gas supplied into the second channel of the heating device is regulated by controlling power output of the gas turbine generating device so that the temperature measured by the temperature measuring device is kept constant.

6. The solar thermal electric power generation system according to claim 1, wherein the heating device is warmed by the exhaust gas from the gas turbine generating device before the Fresnel type heat collectors start to heat the heating medium.

7. The solar thermal electric power generation system according to claim 1, further comprising:
a supplying device for supplying the heating medium in liquid phase to the Fresnel type heat collectors,
a heating device temperature measuring device for measuring an inside temperature of the heating device, and
a heat absorbing pipe temperature measuring device for measuring a temperature of heat absorbing pipes of the Fresnel type heat collectors through which the heating medium in liquid phase flows, wherein
the supplying device starts to supply the heating medium in liquid phase to the Fresnel type heat collectors when temperatures of the heat absorbing pipes measured by the heat absorbing pipe temperature measuring device becomes nearly as high as the inside temperature of the heating device measured by the heating device temperature measuring device.

8. The solar thermal electric power generation system according to claim 1, further comprising an exhaust gas supply quantity regulating device for regulating a quantity of the exhaust gas supplied into the second channel of the heating device by flowing the exhaust gas from the gas turbine generating device to the air.

9. The solar thermal electric power generation system according to claim 1, wherein the heating device comprises heating material for absorbing and storing heat from the heating medium and is configured so as to use the stored heat in the heating material for heating the heating medium.

10. The solar thermal electric power generation system according to claim 9, further comprising a gas quantity measuring device for measuring a quantity of the heating medium in vapor phase, wherein
the heating device is configured so as to absorb the heat from the heating medium by the heating material in case that the quantity of the heating medium in vapor phase measured by the gas quantity measuring device is more than a specified quantity, and
so as to heat the heating medium by the retained heat in the heating material in case that the quantity of the heating medium in vapor phase measured by the gas quantity measuring device is less than the specified quantity.

11. The solar thermal electric power generation system according to claim 9, wherein
the heating device is configured so as to absorb the heat from the heating medium by the heating material in case that a quantity of the heating medium in liquid phase separated by the vapor-liquid separating device is less than a specified quantity, and
so as to heat the heating medium by the stored heat in the heating material in case that the quantity of the heating medium in liquid phase separated by the vapor-liquid separating device is more than the specified quantity.

12. The solar thermal electric power generation system according to claim 1, further comprising a supplying device for supplying the heating medium in liquid phase to the Fresnel type heat collectors, wherein
a quantity of the heating medium in liquid phase that the supplying device supplies to the Fresnel type heat collectors is regulated on the basis of a quantity of the heating medium in liquid phase separated by the vapor-liquid separating device.

13. The solar thermal electric power generation system according to claim 1, wherein the heating medium is water.
